(19) United States
(12) Patent Application Publication
(10) Pub. No.: US 2010/0031152 A1
(43) Pub. Date: Feb. 4, 2010

(54) Creation and Navigation of Infinite Canvas Presentation

(75) Inventors: Shawn A. Villaron, San Jose, CA (US); Jonathan Jay Cadiz, Redmond, WA (US); Jun Yin, Kirkland, WA (US); Jonas Fredrik Helin, Kirkland, WA (US); Robert Paul Sweeney, Bothell, WA (US); Eli Yakushiji Tamanaha, Lynnwood, WA (US); Joy Keiko Ebertz, Seattle, WA (US); Nathan Robert Penner, Mountain View, CA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/184,174

(22) Filed: Jul. 31, 2008

(51) Int. Cl. G06F 3/048

(52) U.S. Cl. 715/731; 715/732

(57) ABSTRACT

A system and method for creating and conducting presentations on a surface may include an authoring mode, a preprocessing mode and a presentation mode. During an authoring mode, a user may create a surface presentation. In response to a command to play the created presentation, the system enters the preprocessing mode. During the preprocessing mode, a presentation is preprocessed and prepared for presentation. When preprocessing is complete, the presentation mode is entered. During the presentation mode, the infinite surface presentation is presented such that a user may navigate through the presentation.

### BACKGROUND

Computers are often used for creating and displaying slide show presentations. Presentations may be configured as a series of slides displayed in a linear format. Presentations may also be displayed as non-linear tours through very large or infinite canvases rather than slides displayed individually and linearly. The creation of such infinite canvas presentations may be difficult and require professional programmers and designers writing special code. Most creators of computerized presentations are not professional designers or programmers, nor do they have the time or ability to write code to create a presentation.

### SUMMARY

A system and method for creating and conducting presentations on a surface may include an authoring mode, a preprocessing mode and a presentation mode. During an authoring mode, a user may create a surface presentation. In response to a command to play the created presentation, the system enters the preprocessing mode. During the preprocessing mode, a presentation is preprocessed and prepared for presentation. When preprocessing is complete, the presentation mode is entered. During the presentation mode, the infinite surface presentation is presented such that a user may navigate through the presentation.

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified:

FIG. 1 illustrates an example computing device arranged for use in a generic validation test framework for graphical user interfaces;

FIG. 2 illustrates an example authoring mode view displaying an example canvas;

FIG. 3 illustrates an example presentation mode user interface;

FIG. 4 illustrates an example presentation in which the portion of the canvas that is displayed has been adjusted to view a particular slide;

FIG. 5 illustrates an example authoring mode user interface in which a user has inserted a section break slide;

FIG. 6 illustrates an example presentation view displaying an example canvas;

FIG. 7 illustrates an example presentation that has transitioned from a canvas zoom level to a section zoom level;

FIG. 8 illustrates an example presentation that has transitioned from a section zoom level to a slide zoom level;

FIG. 9 illustrates an example options interface;

FIG. 10 illustrates an example authoring mode user interface in which a user has inserted a background slide;

FIG. 11 illustrates an example presentation view displaying an example canvas;

FIG. 12 illustrates an example authoring mode user interface in which a user has inserted a live content slide;

FIG. 13 illustrates an example presentation displaying a live content slide;

FIG. 14 illustrates an example authoring mode user interface in which a user has inserted a view command slide;

FIG. 15 shows an alternative authoring mode interface for defining a set of slides and a canvas;

FIG. 16 shows another alternative authoring mode interface for defining a set of slides and a canvas;

FIG. 17 illustrates an example flow chart for a method of defining a slide presentation on a surface;

FIG. 18 illustrates an example flow chart for a method of preprocessing a presentation before the presentation mode has been entered; and

FIG. 19 illustrates an example flow chart (1900) for a method of running a canvas presentation after preprocessing the presentation has been completed.

### DETAILED DESCRIPTION

Embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments described herein are referred to alternatively as operations, steps or modules.

Briefly stated, a system and method for creating and conducting presentations on an infinite surface is described. The system includes at least two user interactive modes of operation, including at least an authoring mode and a presentation mode. During the authoring mode, a user may create an infinite surface presentation. During the presentation mode, a user may display and execute the presentation. In addition, the system includes other modes of operation. For example, the system includes a pre-processing mode of operation that automatically generates the presentation when a user transitions from the authoring mode to the presentation mode.

An authoring mode interface allows a user to create or import content slides. In some embodiments, the content slides may be defined as a linear set of ordered slides. A user may also define special slides to add additional information to the presentational and to control the process by which the content slides are displayed on the surface. In one example, a user may create a background slide for the presentation. The background slide may be used to control how the content slides are arranged on the surface of a canvas. In some examples, the canvas may be an infinite surface, while in other examples the canvas may be of a finite size. An example background slide may include a background image and define the manner in which the slides are arranged on the canvas.

Other special slides may also be available to users. A user may optionally create a section break slide to define sections within the presentation. A section break slide may be utilized to place all of the slides following the section break slide into a physical grouping to create a section. The section may be displayed on the surface as a grouping of related slides.

A user may optionally define a live content slide. A live content slide may be used to automatically generate a slide for an external document and incorporate the live content slide into the presentation. The live content may be arranged on the surface such that the content of the file may be viewed. Though a special slide, because live content slides may define content which will be displayed as a slide on the canvas, a live content slide may have many characteristics similar to that of a content slide. For example, a live content slide may optionally be included in sections, placed in content areas of a background, and viewed using automatic view commands.

A user may optionally define a view command slide. A view command slide may be used to provide instructions for execution during the presentation mode to change the view of the surface to a different view. In some instance, the view command slide may not itself include any content that is displayed. For example, when a view command slide includes a command instruction to rotate the view on the display during the presentation, the view of the infinite surface may be rotated accordingly during the presentation (i.e. in presentation mode).

Once the slide presentation is created, a user may then enter the presentation mode to execute and display the presentation. When a command to play the presentation is initiated, the presentation may be pre-processed (e.g. during a prepossessing mode) by the system to define the infinite surface according to the definition created by the various slides. Preprocessing may include appropriate processing to prepare for the presentation, including but not limited to, processing the slides, loading any live content documents, creating the canvas, and laying out the slides on the canvas. Once preprocessing has been completed and the surface of the canvas is created, a user may navigate though the presentation during the presentation mode.

Navigation may be accomplished by using “automatic commands,” such as next slide commands and zoom commands. An automatic command may be a command to change the view of the presentation surface to an automatically determined next view. When a next command is received, a view of the surface may bring the first slide into full view. When another next slide command is received, the presentation may pan and/or adjust the zoom to bring the next slide into the display. A user may flip through the entire presentation using such next slide commands. A user may also manually adjust the view so that any desired area may be viewed. A user may use manual commands to jump from slide to slide in any order.

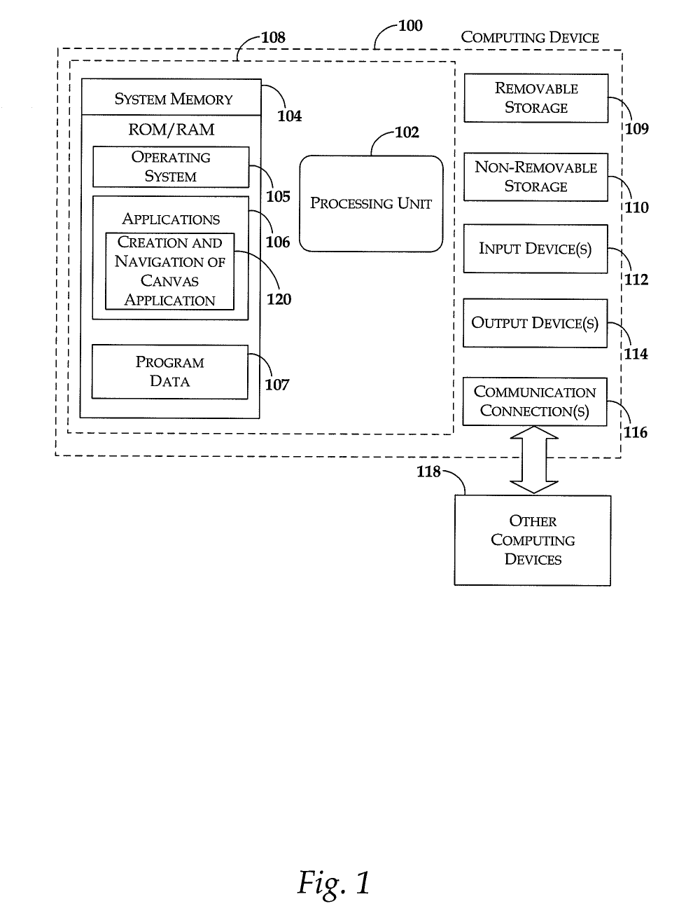

FIG. 1 illustrates an example computing device arranged for use in a generic validation test framework for graphical user interfaces, such as illustrated by computing device 100. In a basic configuration, computing device 100 may include a stationary computing device or a mobile computing device. Computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include application 120, which is arranged as an application for the creation, editing, preprocessing and navigation of a canvas. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included.

Computing device 100 may also contain one or more communication connection(s) 116 that allow the device to communicate with other computing devices 118, such as over a network or a wireless network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

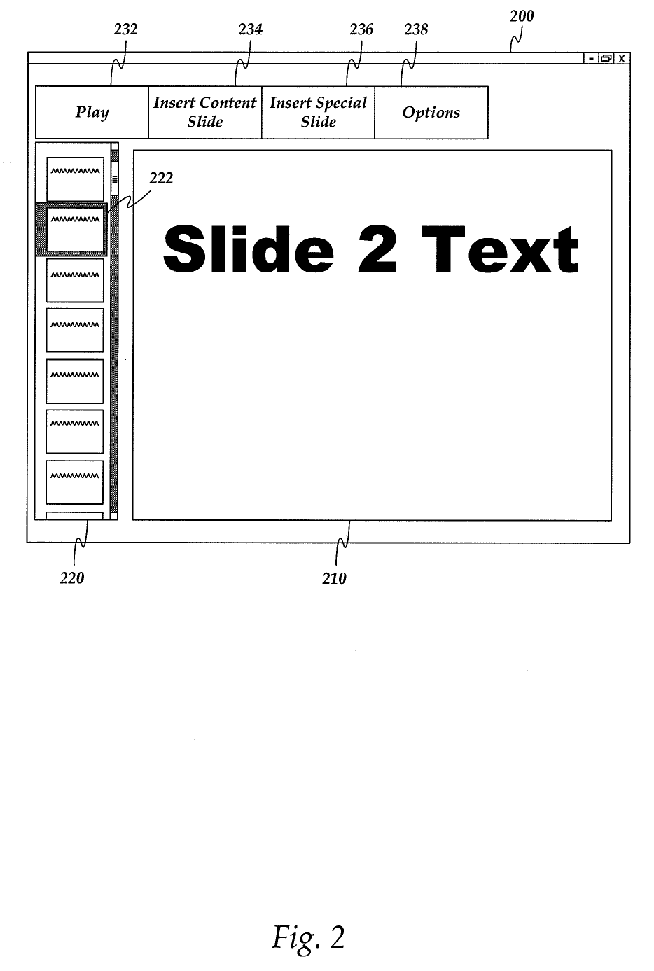

FIG. 2 illustrates an example authoring mode user interface (UI) (200) to enable a user to create an infinite canvas slide presentation. Authoring mode UI 200 may include a slide display region (210) to display a currently selected slide. The slide display region (210) may enable a user to edit the selected slide in a manner similar to that of a traditional slide show editor. For example, a user may add or manipulate text or graphics on the selected slide.

Authoring mode UI 200 may include a slide list toolbar (220) in which a user can view a preview of the slides included in the presentation. The slide list toolbar (220) may also include a graphical indication (222) of which slide is selected. In the example shown in FIG. 2, the second slide is currently selected. Thus, the graphical indication (222) highlights the second slide and the slide display region (210) shows a preview of the second slide. If a user would like to change the selected slide, a user may, for example, simply indicate with a cursor another slide in the slide list (220). In other examples, a user may select another slide in the slide list toolbar (220) using any other indication of a selection as in known in the art, such as my means of other user interface or keyboard, mouse, touchpad etc. commands. In some examples, the slide list toolbar (220) may allow a user to select multiple slides (not shown). When multiple slides are selected, the indication (222) may highlight the multiple slides.

The slide list toolbar (220) may also allow a user to change the order of slides. The order of the slides in the slide list toolbar (220) may control the order in which slides are displayed in the authoring mode. A user may drag and drop (e.g. using, for example, a mouse, keyboard, touchpad, etc.) slides in the slide list toolbar (220) to change the order of the slides. The slide list toolbar (220) may also allow a user to delete a selected slide. In some examples, the slide list toolbar (220) may allow a user to copy and past slides or simply duplicate a selected slide.

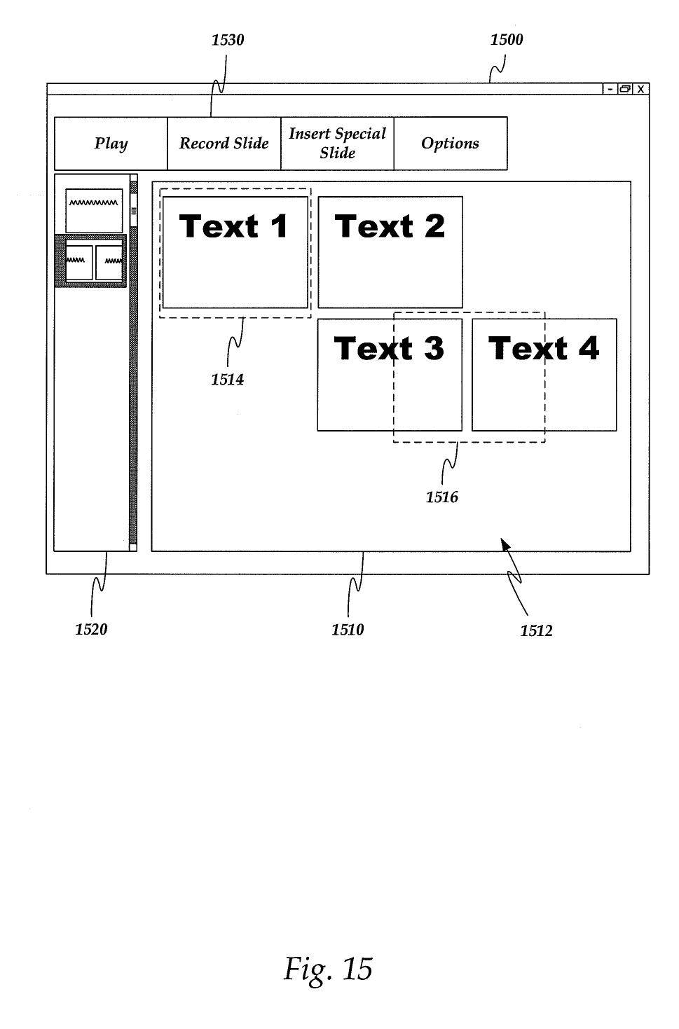

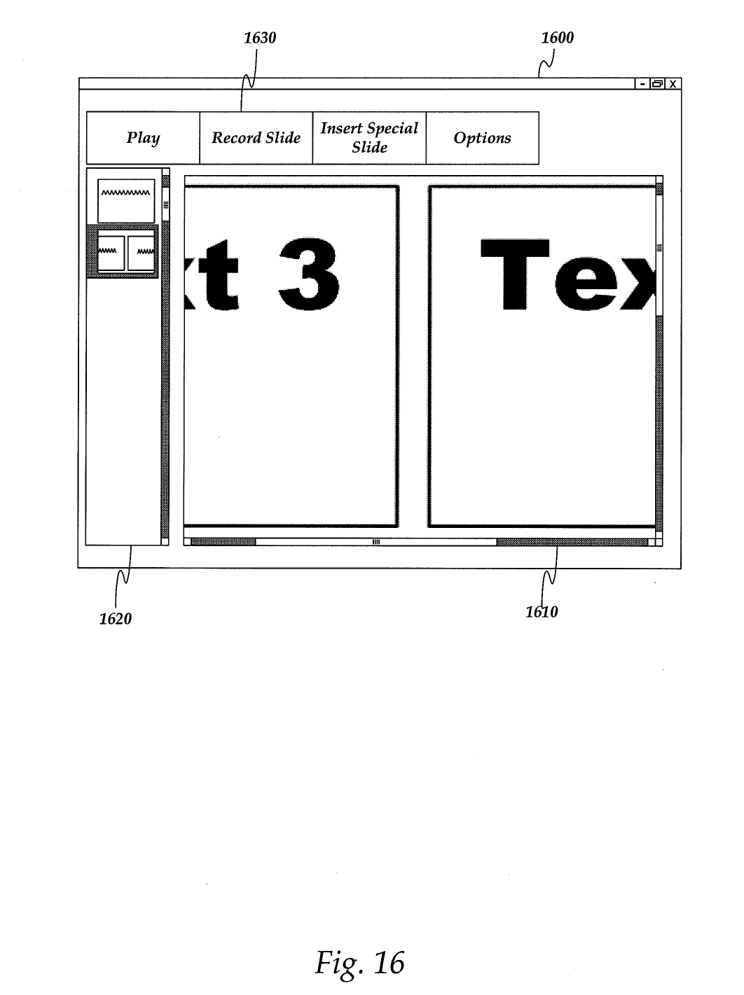

Authoring mode UI 200 may also include control buttons 232-238. Button 232 may be used to play the presentation. As is described further below, a user may select button 232 to exit the authoring mode and enter the presentation mode where the presentation may be executed. Button 234 may be used to insert a new content slide into a presentation. A content slide may be a slide that includes content (such as graphical elements, text, clipart, photograph, other images, spread sheets, graphical elements, etc.) to be displayed in a presentation. A user may create a content slide by directly defining the appearance of the particular slide. In some examples, a user may specify text of a selected content slide that will be displayed in association with the content slide. In this way, content slides may be used to directly define the appearance of material that will be shown during a presentation. Alternative methods of defining content slides are discussed below with reference to FIGS. 15 and 16. In contrast to content slides, a user may also define special slides.

Button 236 may be used to insert a new special slide into a presentation. A special slide may be used by a user to control aspects of the presentation other than the direct appearance of a particular slide. For example, a user may use button 236 to insert a background slide. A background slide may be used to define the appearance and layout of the canvas on which content slides will be presented. A user may use button 236 to insert a section break slide to control whether content slides are grouped into sections. A user may use button 236 to insert a live content slide to reference content stored in a separate file. A user may use button 236 to insert a view command slide to control the manner in which the presentation is viewed.

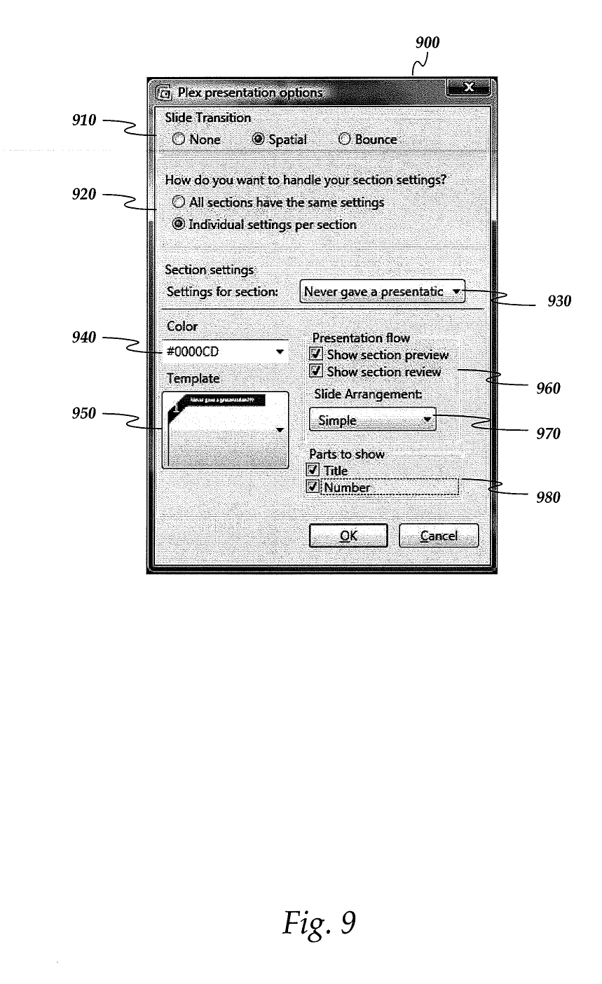

Button 238 may present the user with an advanced options menu that allows a user to have more control of over the presentation. An example options menu is discussed below with reference to FIG. 9.

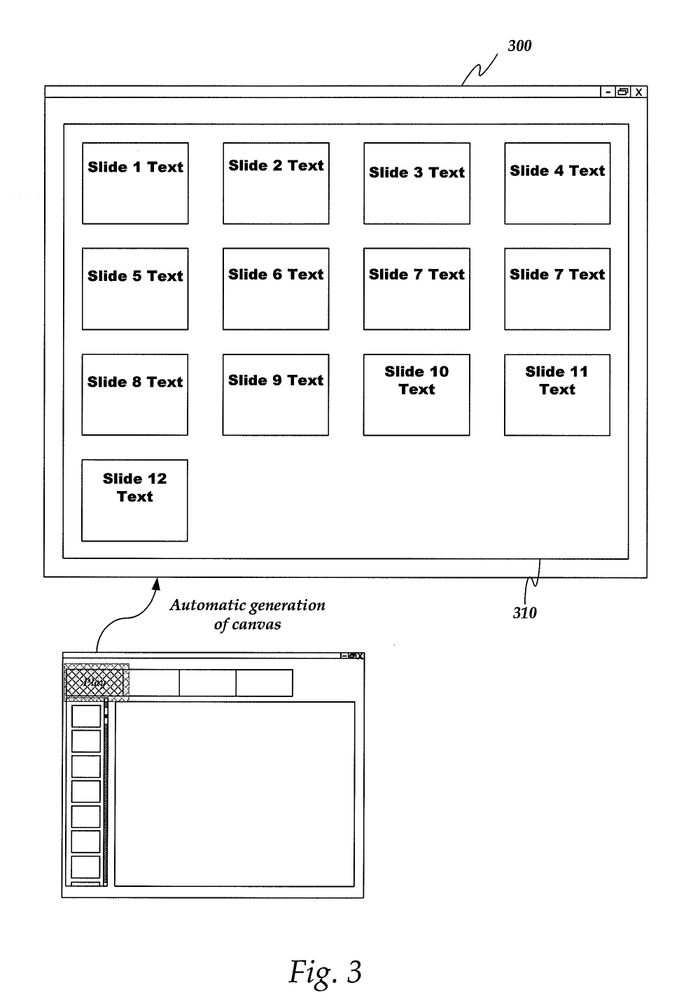

FIG. 3 illustrates an example view of a presentation mode user interface (300). The presentation mode UI (300) displays an example canvas (310). A canvas may include a collection of slides arranged in an order on a background. The arrangements may include hierarchical groupings of slides or may simply include a free arrangement of slide. The presentation mode UI (300) may display all or a portion of the canvas (310). In some examples, the canvas (310) may be an infinite canvas while in other examples it may be of a finite size.

As is explained further below, canvas 310 is automatically generated during preprocessing mode and displayed in the presentation mode when a user selects the play button (232). The presentation mode user interface allows the user to navigate through the canvas (310) using automatic navigation commands and/or manual navigation commands.

Automatic navigation commands may include commands to display an automatically determined portion of the canvas. In one example automatic command, a user may use a next slide command to request that a next slide be shown. In response, the presentation mode UI (300) may automatically adjust the portion of the canvas (310) displayed by zooming into the next slide such that it fills the viewable area of the device on which the presentation is being displayed, such as a computer monitor or overhead projector.

In another example automatic command, a user may similarly use a previous slide command to request that a previous slide be displayed. The presentation mode user interface (300) may then automatically display the previous slide in a presentation by zooming into the previous slide.

In still another automatic command, a user may use an automatic zoom in command to request that the presentation mode user interface (300) automatically zoom into a particular slide. Similarly, a use may use an automatic zoom out command to request that presentation mode user interface (300) automatically zoom out to show the full canvas. In this manner, automatic view commands may instruct the presentation mode user interface (300) to automatically modify the manner in which the canvas (310) is displayed.

In addition to such automatic view commands, a user may also manually adjust the manner in which the canvas (310) is displayed using manual view commands. For example, a user may manually adjust the zoom level of the presentation view using presentation mode user interface (300). A user may manually pan the presentation view using presentation mode user interface (300). In this way, a user may manually move presentation view between complete slides or view regions of the canvas (310) not otherwise possible by means of automatic commands.

In another example manual command, a user may zoom into to a particular portion of a slide so that detail that may otherwise be too small is visible as part of a presentation. A user may also zoom out so that multiple slides are visible or so that only part of a slide is visible. Manual zoom and pan commands may, therefore, allow a user to dynamically interact with the presentation to selectively display any portion of the canvas (310) in any manner desired.

In some examples, manual view commands may include commands to rotate the canvas (320) or to adjust other view properties such as brightness, contrast or colorization of the canvas.

Both manual and automatic view commands may be inputted during presentation mode using any desired input device. For example, a user may navigate the through the canvas (320) using a mouse, a keyboard, or any other user interface device such as a specialized slide presentation control device (e.g., a wireless remote control). In other examples, the user may use a touch pad or touch screen.

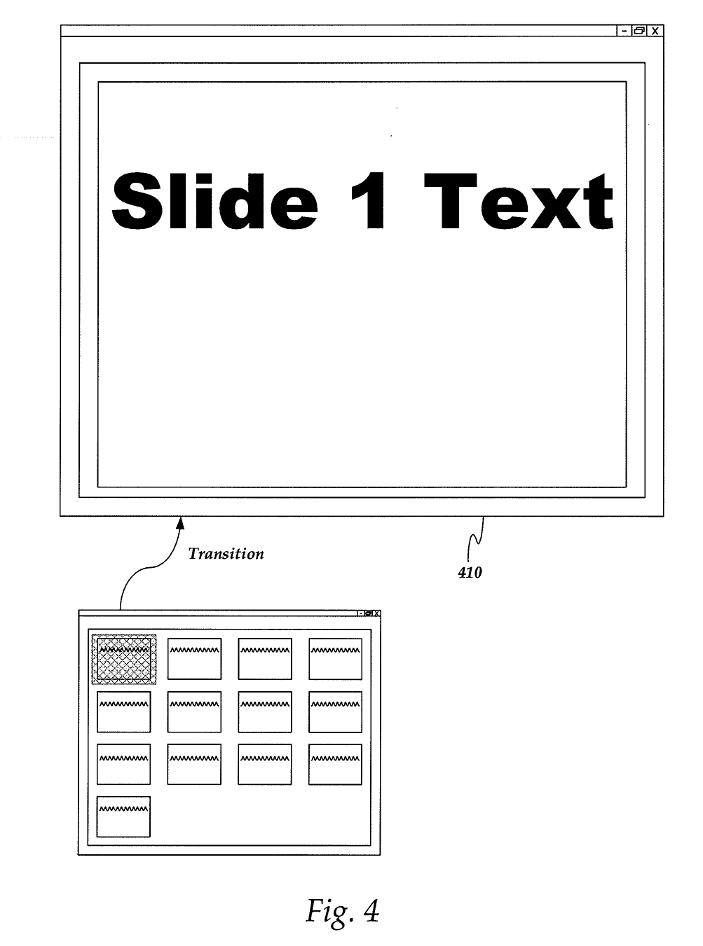

FIG. 4 illustrates an example presentation 400 in which the portion of the canvas that is displayed has been adjusted such that a particular slide is being viewed. Such a transition may occur, for example, when a user associates the first slide on the canvas with an automatic zoom command that is expected. In response, the presentation mode user interface may then automatically transition to a zoomed view of the first slide in presentation 400. In this way, two zoom levels may be automatically cycled between: a slide zoom level (as shown by presentation view 400) and a canvas zoom level (as shown by presentation view 300).

A user may also transition to the presentation view (400) if the user initiates a next slide command. For example, when the user is viewing the full presentation and a next slide command is processed, the presentation mode user interface may automatically zoom to the first slide and transition to the presentation view (400). When a particular slide is being viewed, such as is shown in presentation view (400) and another next slide command is processed, the mode user interface may automatically advance to the next slide in the slide list. For example, the canvas may be automatically panned to the second slide of the presentation. In this way, a user may use the next slide command to step through a full presentation.

While stepping through a presentation, the presentation mode user interface may track which slide is a current slide. If a user changes the view by, for example, zooming out or using a manual view command, the presentation mode user interface can keep track of which slide is the current slide even when the current view has been manually altered. Thus, when a next slide command is received, the presentation will continue from the current slide to the next slide even though the current view has been changed.

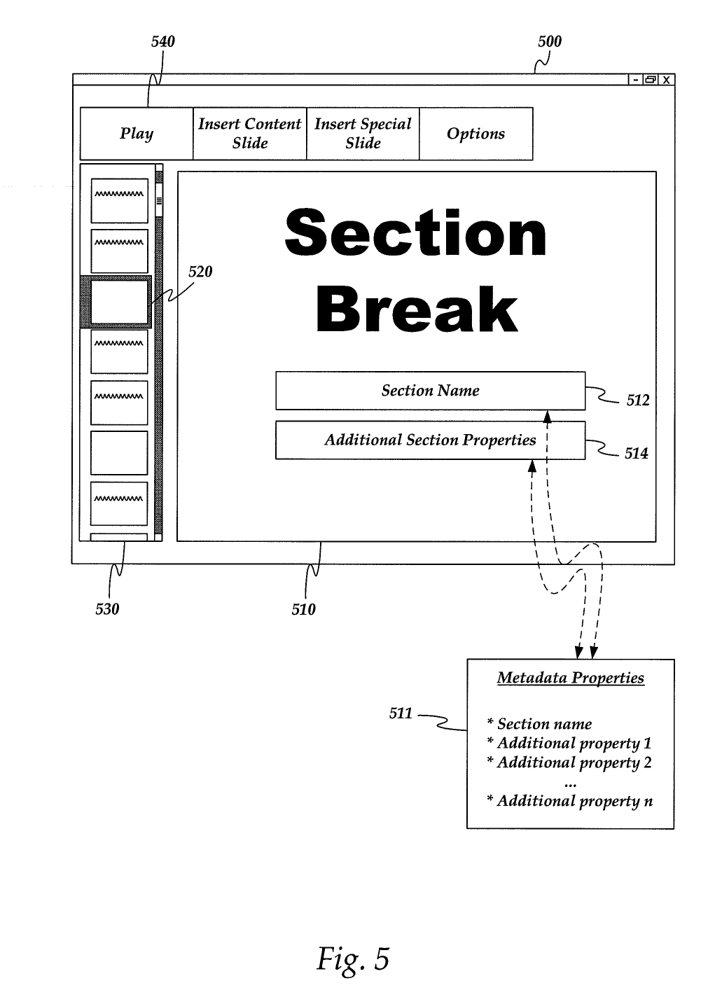

FIG. 5 illustrates an example authoring mode user interface (UI) (500) in which a user has inserted a section break slide (510). The section break slide (510) may be displayed in the slide list toolbar as a highlighted (e.g., shaded, inverse video, etc.) slide (520) labeled as a section break. The section break slide (510), however, may be defined by a set of metadata properties (511) that describes how the section will be created (e.g. rendered) when the slide show is played via the presentation mode user interface. Rather than defining the appearance of a particular slide directly, as it is a special slide, the section break slide (510) is defined by metadata (511) that describes how the section will later be created when the presentation is played.

The authoring mode user interface (UI) (500) may include a slide list toolbar 530 similar to that of the slide list toolbar 220 of FIG. 2. The slide list toolbar 530 may graphically show a linear, ordered list of slides. The order of the slide list toolbar (530) may represent the order in which slides will be displayed in the presentation mode. The slide list toolbar (530) may include both content slides and section break slides. The slide list toolbar (530) may enable a user to move and manipulate the order of section break slides and content slides similar to that of the slide list (220). In this manner, the location of the section break slide (510) can be adjusted to alter adjust the members of the section. This may allow a user may easily control which slides are members of which sections.

Regions 512 and 514 of slide 510 may be included that allow a user to modify the metadata (511) that is stored in association with the section break slide (510). For example, a section name user interface portion (512) may be included. Region 512 of slide 510 may be arranged to enable a user to name the section that will be created. Region 514 of slide 510 can be associated with additional section properties to allow a user to edit additional section properties. For example, the section break slide (510) may be associated with metadata (511) that controls how slides are grouped into the section. The metadata (511) may describe the members of the section using either relative slide references or absolute slide references.

Relative slide references may include a reference to a slide based on its location in the slide list toolbar (530) relative to that of the section break slide (510). For example, the metadata (511) may specify that all slides in the slide list toolbar (530) after the section break slide (510) are to be included within the section. In other examples, all slides after the section break slide (510), but before a next section break slide, may be included within the section break defined by slide 510. In still other examples, the slides to be included in the section may be defined by specifying the number of slides following the section break slide (510) that are to be included. For example, a section may be defined such that the next five slides after the section break slide are included in the current section.

Absolute slide references may specify a slide number independent of the location of the section break slide (510). For example, the metadata (511) may specify that the second and fourth slides in the slide list toolbar (530) are to be included within the current section. As described above, metadata properties may define the members of the section using definitions based on relative slide references and/or based on absolute slide references.

Additional metadata may also control whether the current section is nested within another section. For example, sections may be hierarchically defined such that a current section is a child section (or subsection) of a parent section. In this manner, a section may be defined as a subsection of another section.

Still other metadata may control how a section is graphically displayed. For example, metadata may define the font and font size for a section title is to be displayed. Other metadata may define the appearance of the section, such as a particular background color, border that may be drawn around a section, font, theme, color scheme, shading, or size and positioning of member slides. In this manner, metadata properties 520 may be used to define all aspects of how a section is created and displayed.

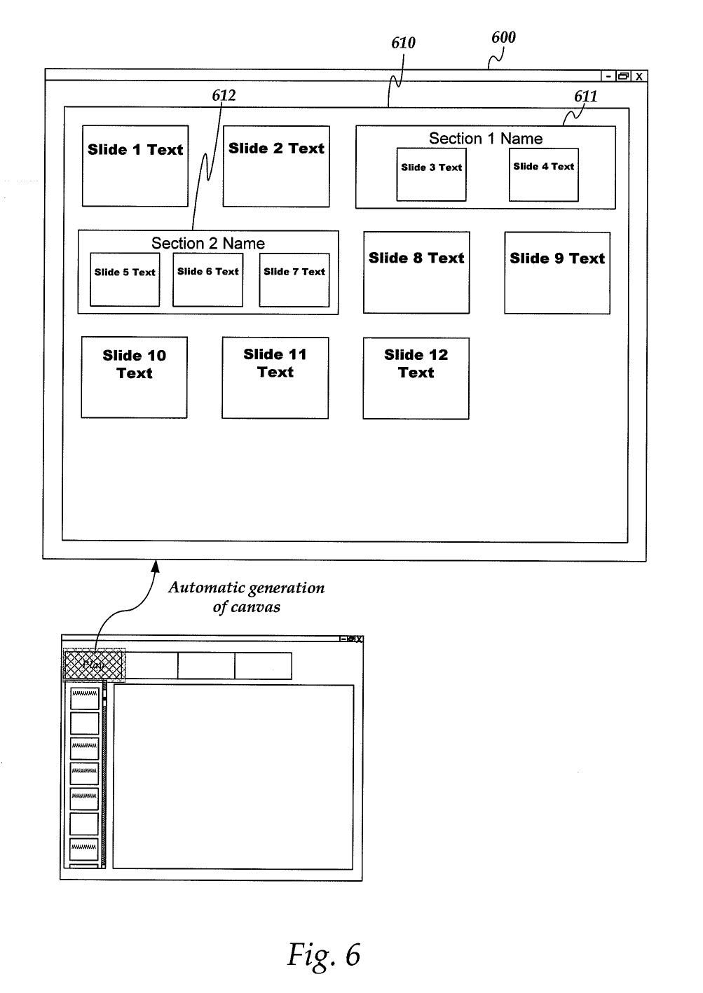

FIG. 6 illustrates a presentation view (600) displaying an example canvas (610) created from the slide list (510) of FIG. 5 in response to a user selecting the play button (540). In this example, the presentation view (600) is zoomed out such that all the slides in the canvas (610) may be viewed. The canvas (610) includes twelve example content slides. Five of the content slides are grouped into two sections, while the remaining seven slides exist outside of any section. A first section includes the third and fourth slides while a second section includes the fifth, sixth and seventh slides.

In this example, the first section (611) was created when a first section break slide was processed. The first section break slide included metadata that specified the section was to include all slides after the first section break slide, but before a next section break slide. As can be seen in the slide list toolbar (530) of FIG. 5, two slides exist after the first section break slide but before the second section break slide. Thus, when pre-processing the presentation slides three and four were included in the first section (611). In other examples, the first section may have included different metadata that defined the contents in a different manner, yet still resulted in a section having the same members. For example, the first section (611) may be defined manually with absolute instructions to include slide three and to include slide four. In still other examples, the first section (611) may be defined with relative instruction to include the next two slides following the section break. In any case, the result would be the same: the automatic creation of a first section (611) that includes slides three and four. The second section (612) may be defined in a similar manner to the fifth, sixth and seventh slides.

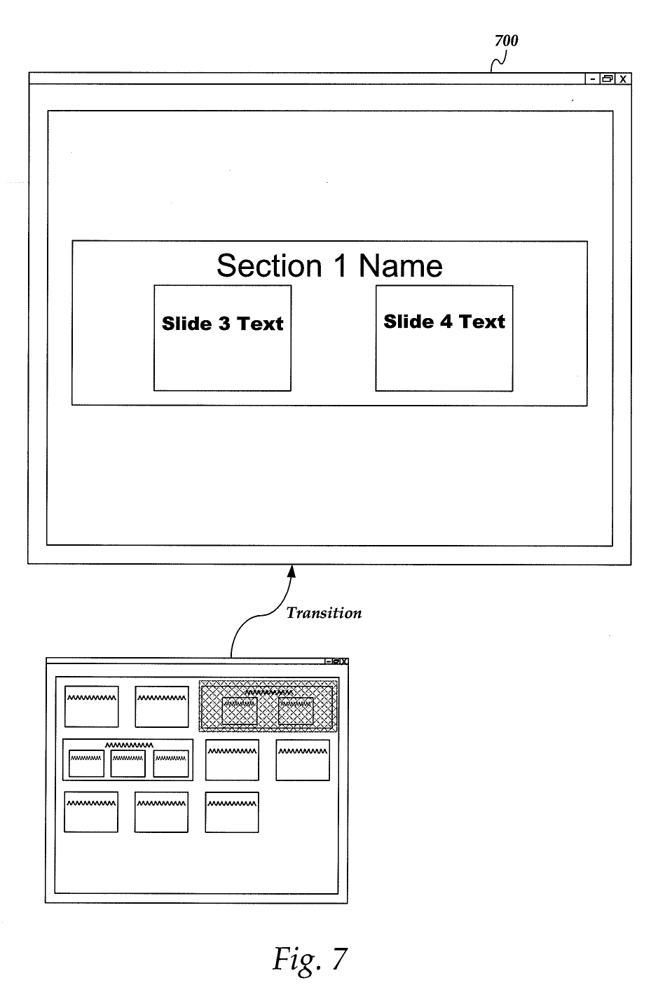

The presentation (610) may be navigated similarly to that of the canvas illustrated in FIG. 3. The slides may be advanced by means of a next slide command. As there are sections in presentation 610, three levels of zoom may be automatically cycled between, rather than two: a canvas zoom level, a section zoom level, and a slide zoom level. The canvas zoom level may simultaneously display all of the slides on the canvas (e.g. 600 of FIG. 6). The section zoom level may display all of the slides of a particular section (e.g. 700 of FIG. 7). The slide zoom level may show a particular slide (e.g. 410 of FIG. 4).

Thus, when a slide within a section is selected from the canvas zoom level, and a first zoom in command is processed, the zoom level may be automatically changed from the canvas zoom level to the section zoom level. When a second zoom command is then processed, the zoom level may automatically be changed from the section zoom level to the slide zoom level. Similarly, when a first zoom out command is processed, the zoom level may cycle from the slide level to the section level. When a second zoom out command is processed, the zoom level may cycle from the section zoom level to the canvas zoom level. In this manner, the automatic view commands may be utilized to easily view sections and slides.

The next slide command may be used to advance or cycle through slides that are in a section. The manner in which slides within a section are cycled through when a next slide command is processed depends on the metadata properties of the section. As discussed in more detail below with reference to FIG. 9, a section may include a metadata property that indicates a preview and/or a review should be generated for presentation. If the preview option is selected for a section, before the first slide is displayed, the zoom level is automatically adjusted to the section zoom level when a next slide command is processed during presentation. Once in the section zoom level, upon processing of another next slide command, the zoom level is adjusted to the slide zoom level. Upon processing of another next slide command, the next slide is shown. If the review option has been selected, a section view may be shown. For example, when the last slide has been reached, before the section is exited, the zoom level is changed to the section zoom level again when another next command is received.

As described above, the automatic preview and review option allows the presentation to cycle through the slides and view the section as a whole before entering the section and before leaving the section. This allows a presenter to introduce a section, cycle through the slides in a section, and to summarize a section through us of a single type of user input: a next slide command. In some examples, a user may also select the section title to view a section overview.

In order to facilitate processing, when the zoom level is beyond the slide zoom level (e.g. at a section or canvas zoom level) a lower quality image of the slide may be used. When the zoom level is at the slide level (or higher), a higher quality image of the slide may be used. In this way, when less detail is required, fewer processing resources may be utilized to display the presentation. When the zoom level changes, the transition between the different versions of the slide may use a fading algorithm such that the transition is difficult for a presentation viewer to detect. In other examples, more than two images of each slide may be generated, such as a low-quality image, a medium quality image, and a high quality image. Such images may be generated, for example, during the preprocessing mode.

FIG. 7 illustrates an example presentation (700) that has transitioned from a canvas zoom level to a section zoom level. This transition may occur when a user selected the third slide and executes a zoom in command requesting an automatic increase in zoom level. This transition may also occur when the second slide was selected, and a next slide command was thereafter processed. If the preview option has been selected, a section view may be shown. For example, before the section is entered and the first slide displayed, the zoom level is changed to the section zoom level when a next command is received. This may allow a presenter to first discuss an overview of the section.

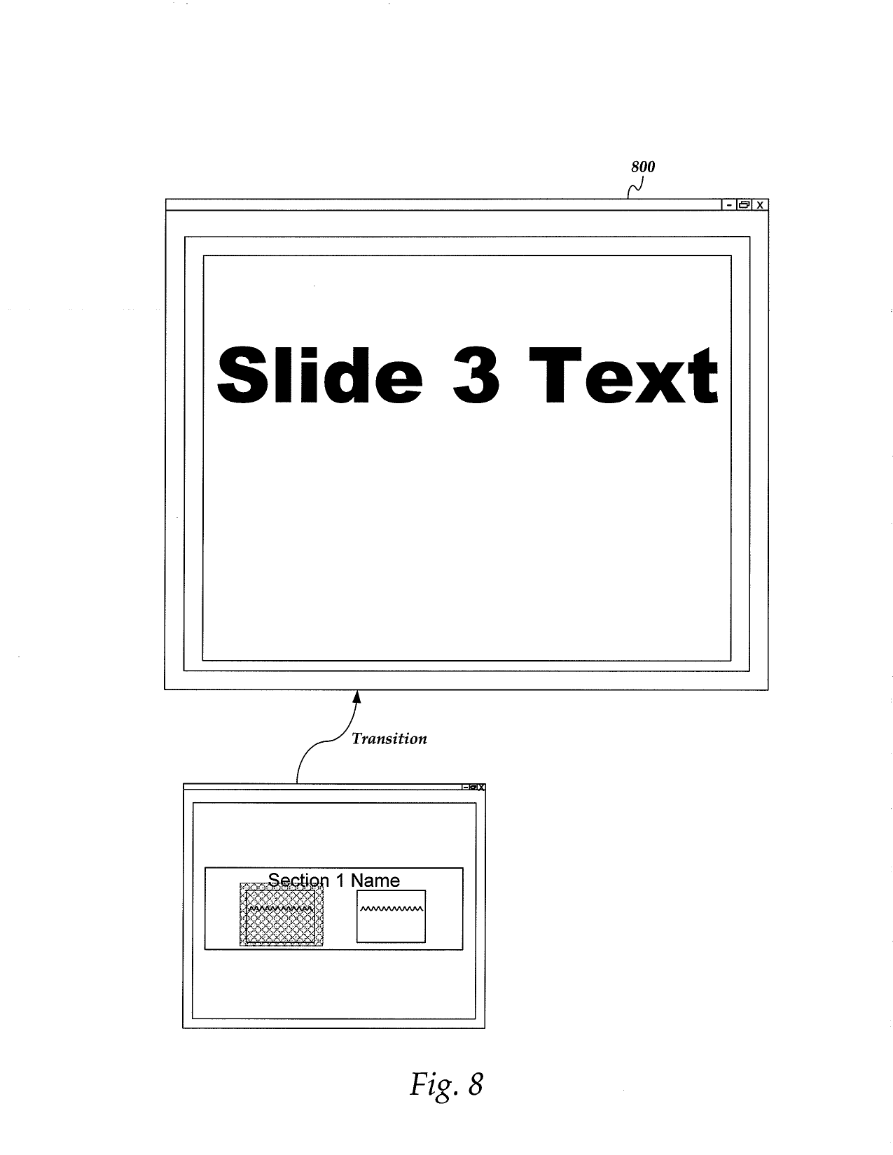

FIG. 8 illustrates an example presentation (800) that has transitioned from a section zoom level to a slide zoom level. This transition may occur when a user selected the third slide and an automatic zoom command is executed to increase in zoom level. The appropriate zoom level to display the slide would be automatically calculated and the slide is displayed. This transition may also occur when a next command is processed following the display of a section preview as described above.

FIG. 9 illustrates an example options interface (900) to allow a user to control options related to a presentation, as well as define metadata associated with particular sections. Options interface 900 includes a slide transition selector (910) to allow a user to select the manner in which the slides are transitioned between during presentation mode. A user may select “None” to indicate that the view of the canvas should instantaneously be updated to show the next slide with no animation. A user may select “Spatial” to indicate the view of the canvas should pan (a spatial transition effect) to the next slide. A user may select “Bounce” to indicate that the view of the canvas should zoom out of the current slide, pan, and zoom back in on the next slide (a bounce effect). In other examples, other slide transitions maybe made available to the user, such as animation fades, rotations, or other transitions as is known by those of skill in the art.

The options interface 900 may include a section uniformity selector (920) that allows a user to select whether properties of sections may be individually controlled. A user may select “All sections have the same setting” to indicate that all slides in the sections share common metadata properties. When this option is selected, a user need only define sections properties once, and the properties will be applied to all sections in the document. When a user wishes to individually adjust different sections' settings, a user may select “Individual settings per section” in the section uniformity selector (920).

When the user has selected “Individual settings per section” in the section uniformity selector (920), a section setting selector (930) may be activated that allows a user to select a particular section (e.g. a pull down menu button). Once a particular section is selected, a user may then individually control the section metadata properties of the selected section via controls 940 to 980. When the user has selected “All sections have the same settings” in the section uniformity selector (920), changes in controls 940 to 980 will be applied to all sections uniformly. In this way, options menu 900 provides another user interface that enables a user to edit metadata properties for sections.

The options interface (900) may include a template color selection control (940) that allows a user to select a color in which a section background may be displayed. A color may be selected by allowing a user to input a hexadecimal color, graphically select a color from a color wheel or by other methods of selecting a color as is known by those of skill in the art.

The options interface (900) may include a section template selection control (950) that allows a user to choose a selection template to control the appearance of a section. Section templates control the graphical layout and appearance of slides within a section. For example, a border or a background color may be displayed for a section. The section templates allow a user to select a particular style or theme of section border or background. The manner in which the selected section template is displayed may depend on the color selected by a user via the template color selection control (940).

The options interface (900) may include a presentation flow control (960) that allows a user to select whether section previews and section reviews will automatically be displayed when a user is cycling through a presentation. For example, when “Show section preview” has been selected, the view in the presentation mode will automatically zoom to a section zoom level before individual slides are viewed in response to executing a next or previous slide command. Similarly, when “Show section review” has been selected, the view in the presentation mode will automatically zoom to a section zoom level after all individual slides of a section are viewed in response to executing a next or previous slide command.

The options interface (900) may include a section slide arrangement control (970) that allows a user to select the manner in which slides are arranged when a section is a generated for a canvas. For example, a user may select “Simple” to indicate slides should be arranged in a grid and ordered from top to bottom, left to right. Other options may enable the slides to be arranged in a square, triangle, polygon, spiral pattern, a zigzag pattern, a random or pseudo random pattern, a manually user defined pattern, or any other pattern known by those of skill in the art.

The options interface (900) may include a section parts control (980) that allows a user to select the parts of a section template to be displayed on a canvas when the section is generated. A user may select “Title” to indicate that the title of the section should be displayed on the canvas. A user may select “Number” to indicate that the section number should be displayed on the canvas. In this way, the manner in which a section is displayed and arranged on the presentation mode canvas may be controlled via the options interface (900).

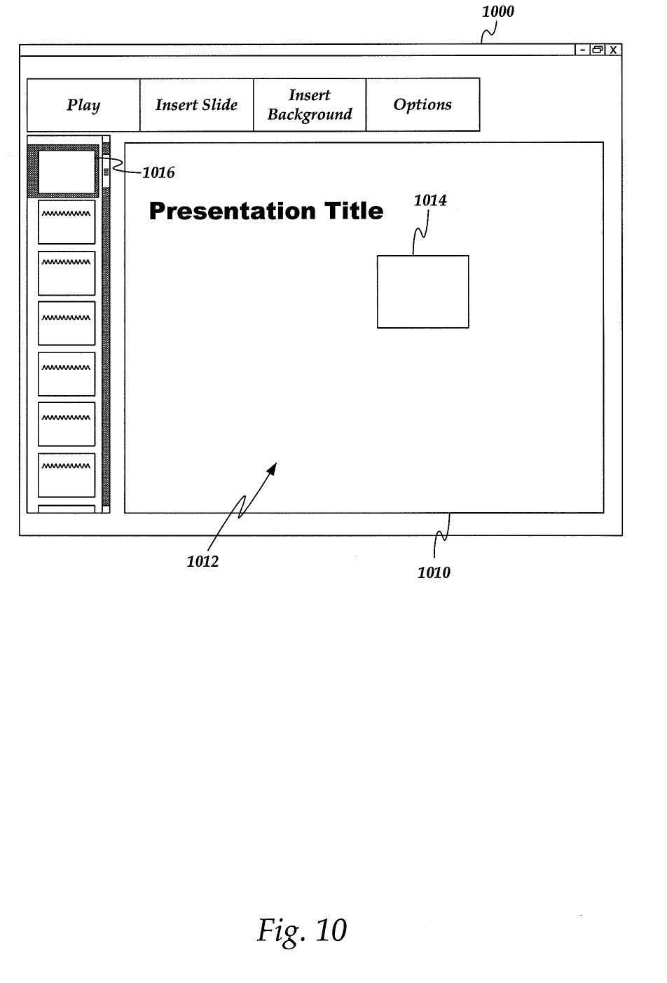

FIG. 10 illustrates an example authoring mode user interface (1000) in which a user has inserted a background slide (1010). The background slide (1010) may be displayed in the slide preview list as a slide (1010) that shows the canvas background. Although shown in the slide preview list, rather than defining the appearance of a particular slide directly, the background slide (1010) defines the canvas upon which other slides will be placed. The background slide (1010) may include background image(s) (1012) or text. In some examples the background image (1012) may be solely an aesthetic (e.g. a picture, a graphical illustration, clipart, etc.) added to give interest to the presentation. In other examples the background image (1012) may also include information that gives context to the slides that are arranged on the background. For example, slides may be placed on a portion of the background image that relates to the slides. The background image (1012) may also be used to indicate groups of slides for organizational purposes.

The background slide (1010) may include a context box (1014). The context box (1014) is a portion of the background slide onto which content slides may be placed when the canvas is generated. In some examples, the background slide (1010) may include a single context box (1014) onto which all slides may be placed. In other examples, the background slide (1010) may include multiple context boxes (1014), each associated with a particular section. In this manner, the background slide (1010) can control the appearance and layout of the canvas generated for presentation of the slide show.

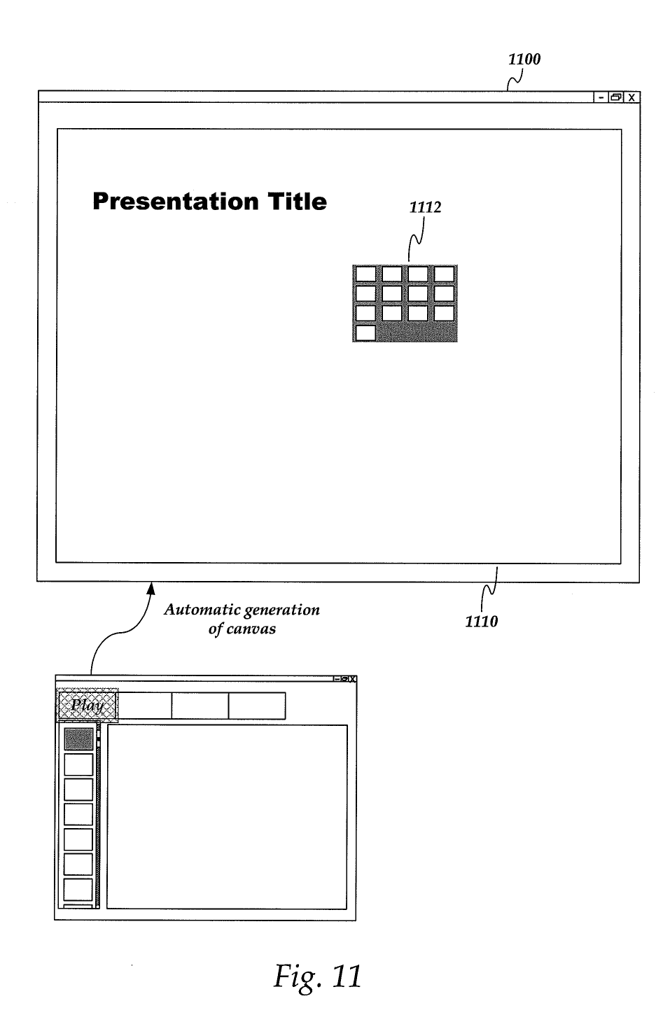

FIG. 11 illustrates an example presentation view (1100) that includes a canvas 1110 that is automatically generated during a preprocessing mode when a user selects the play button. The canvas 1110 includes each of the slides of the presentation arranged onto a background generated in response to the background slide. Specifically, the slides are places in a location (1112) that is associated with the context box (1014) of FIG. 10. In addition, the canvas includes the image of the background slide (1010) of FIG. 10. In this way, the canvas is generated in response to both the image (1012) of the background slide (1010) and the defined context area (1014) of the background slide (1010).

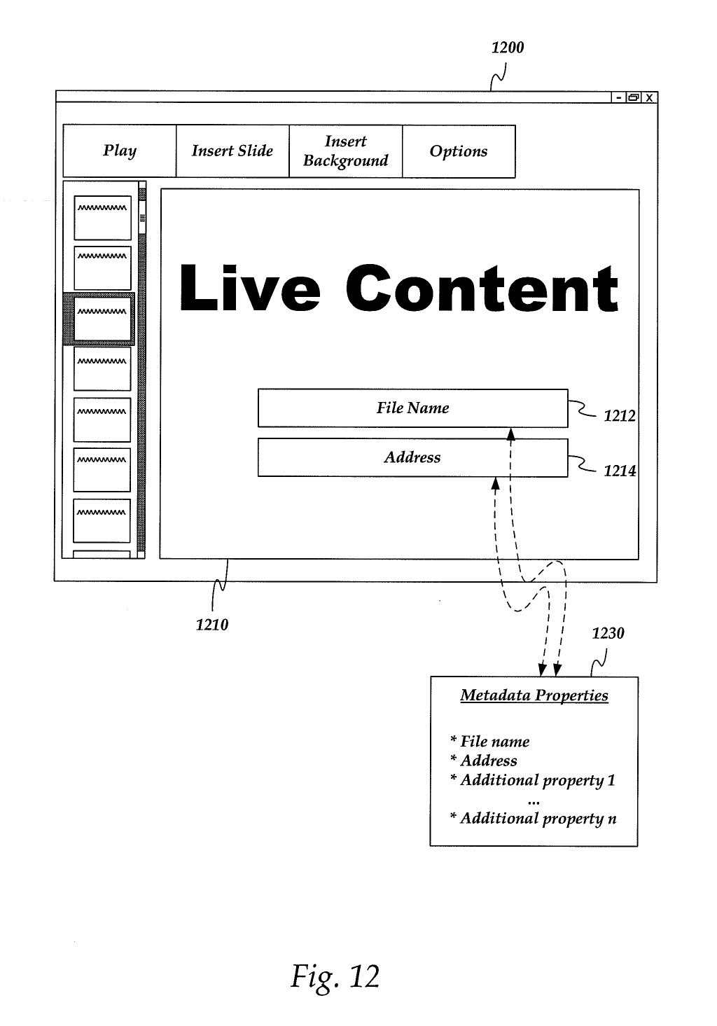

FIG. 12 illustrates an example authoring mode user interface (1200) in which a user has inserted a live content slide (1210). The live content slide (1210) may be displayed in the slide preview list as a slide labeled appropriately. Rather than defining the appearance of a particular slide directly, as a live content slide is a special slide, the live content slide (1210) is defined indirectly by an external source. Specifically, the live content slide (1210) may include a link to a file (such as a document, image, spreadsheet file, or other type of file) that will be displayed as a slide during the presentation mode.

User interface portions may be included on the live content slide (1210) that allows a user to modify metadata (1230) that is stored in association with the live content slide (1210). For example, a file name user interface portion (1212) may be associated with live content slides 1210. The file name UI portion (1212) may enable a user to enter the name of a file that will be linked to the live content slide (1210). A file address user interface portion (1214) may also be associated therewith. The file address user interface portion (1214) allows a user to a select the location in which the file is located. In some examples, the file address may be a relative address. That is, the file address may describe the location of the file associated with the live content slide relative to the location of the presentation file itself. In other examples, the file address may be an absolute address. An absolute address may be used when the file is not located within a folder that is a child of the folder in which the presentation file is stored (or perhaps as a subfolder accessible therefrom). In a preferred embodiment, the determination of whether an absolute or a relative address is used is determined automatically. This determination may be in response to the location of the file relative to the presentation file.

Additional metadata properties (1230) may also be associated with the live content slide (1210). For example, additional metadata properties may control how a live content file is displayed, the file type of the live content file, and properties to control the interaction with the live content file during presentation mode, etc.

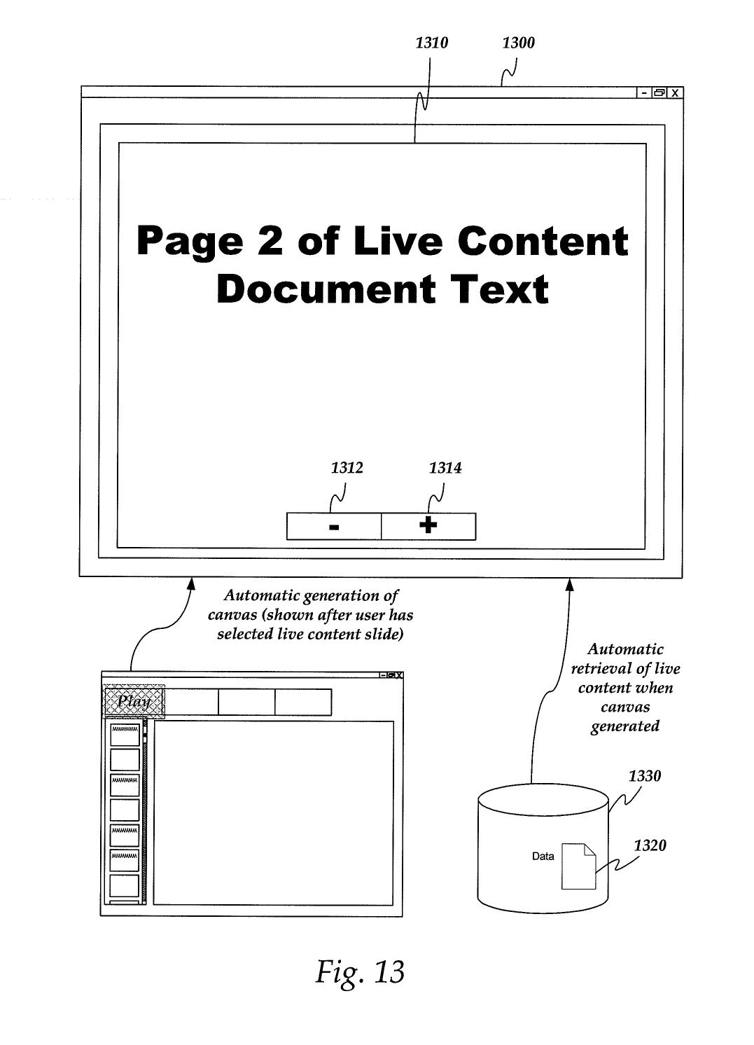

FIG. 13 illustrates an example presentation (1300) displaying a live content slide (1310). The live content slide (1310) may be represented in the presentation by a rendered representative image of a file (1320) stored in a data store (1330) separate from that of the presentation. The data store (1330) may also store the presentation file or it may be a separate data store (not shown). The file (1320) referenced by the live content slide, however, is a different file from the presentation file itself.

When a user selects the play button, such that the canvas is automatically generated during preprocessing mode, the file (1320) is located using to metadata stored in association with the live content slide, such as the address and document name metadata (1230) of FIG. 12. Once the file (1320) is located, the type of the file is identified. Once the file type is identified, an image of the file as it would appears if it was rendered in its native application associated with the file type is rendered. For example, when the file is a spreadsheet, an image is rendered that appears as if the spreadsheet was being viewed in the native spreadsheet program associated with the file type. Similarly, when the file is a document, an image of the document is rendered that appears as the document would appear if viewed in a word processing application associated with the file.

The version of the file (1320) that is rendered into an image may be that which is retrieved from the data store (1330) when the play button is selected. In this way, the most recent version of the file (1320) is pulled each time the presentation begins. In other examples, the file (1320) may be updated more or less frequently. For example, in some examples a copy of the file (1320) may be loaded when the presentation is loaded such that the same version of the file (1320) is used each time the presentation is run. In other examples, a copy of the file (1320) may be loaded each time the live content slide (1310) is displayed. Such an example would allow for the file (1320) to be updated while the presentation is being executed.

The file (1320) may have multiple pages. For example, the file (1320) may be a four page text document. When the file (1320) contains multiple pages, the presentation mode interface (1300) may include live content page controls, such as previous page control 1312 and next page control 1314. A user may use the previous page control (1312) to display the previous page of the file (1320). For example, FIG. 13 shows the second pages of the file being viewed (1310). A user can, therefore, use the previous page control (1312) to view the first page of the file (1320). Similarly, a user can use the next page control (1314) to view the third page of the file (1320). Accordingly, the user may use previous page control 1312 and next page control 1314 to navigate through a multi-page live content slide.

A user may also use standard navigation commands of the presentation mode interface 1300 to interact with the presentation of live content slide (1310). For example, a user may use manual and/or automatic zoom and pan commands to view a desired portion of the document within the live content slide (1310) such that fine details may be viewed during a presentation.

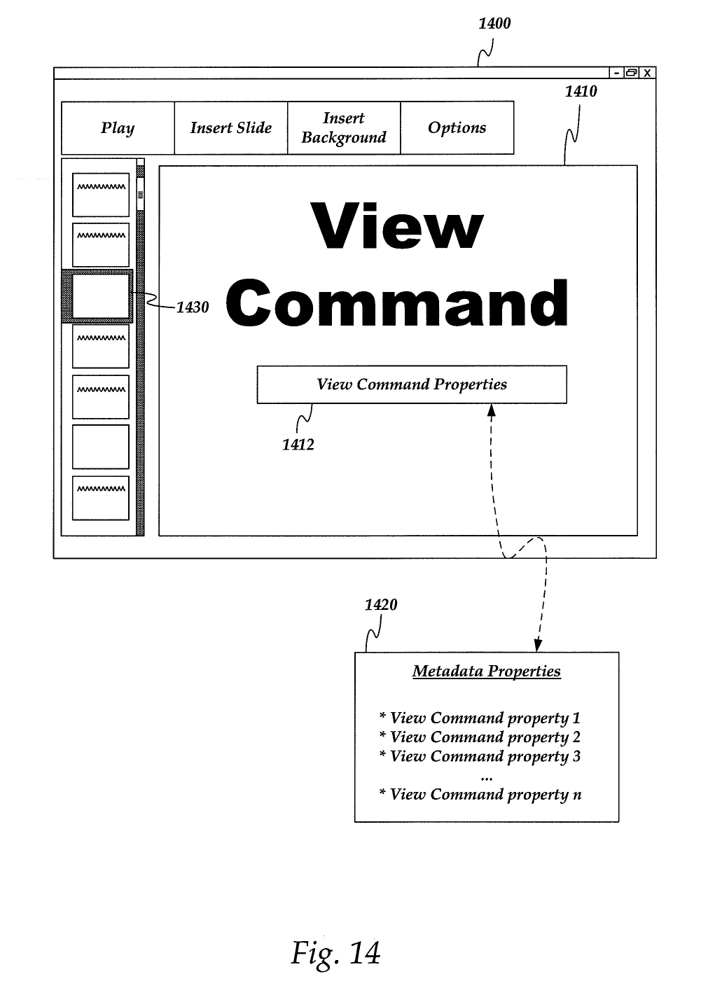

FIG. 14 illustrates an example authoring mode user interface (1400) in which a user has inserted a view command slide (1410). The view command slide (1410) may be displayed in the slide list as a slide (1430) labeled appropriately. Rather than defining the appearance of a particular slide directly, as a view command slide is a special slide, the view command slide (1410) defines a transition between two views in a presentation. For example, the view command slide (1410) may be used to define a transition between the second slide and the third slide of the presentation. The transition of the view command slide (1410) may be defined through use of metadata properties 1420 that are associated with the view command slide (1410).

User interface controls may be included on the view command slide (1410) that allow a user to modify the metadata properties (1420) that are stored in association with the view command slide (1410). For example, a view command properties interface portion (1412) may be included in view command slide (1410). This interface may enable a user to define the particular type of transition. For example, metadata properties (1420) may define whether there is no transition, a “Spatial” transition, or a “Bounce” transition (as is described above with reference to FIG. 9). The metadata properties (1420) may also control when the transition is applied (e.g., entering the slide, exiting the slide, 50 ms into the slide, triggered in the slide). The transition may be applied with reference to the relative location of the view command slide (1410) in the slide list. For example, the view command may be applied between the slide before (slide 2) and the slide after (slide 3) the view command slide (1410). In other examples, the transitions application may be applied independent of the view command slide's (1410) relative location in the slide list. For example, the view command may be applied at each transition.

FIG. 15 shows an alternative authoring mode interface (1500) for defining a set of slides and a canvas. Rather than a user first defining a set of slides and an application then automatically generating a canvas therefrom (as is described above), the authoring mode interface (1500) provides a user interface that allows a user to first define a canvas and the user then define slides within the canvas.

The authoring mode interface (1500) includes a canvas preview display portions (1510) that a user may use to define a canvas, such as canvas 1512. In some examples, a user may define the canvas (1512) using traditional page layout, word processing, and graphical design methods. In other examples, a user may import a file for use as the canvas (1512). For example, a user may important a bit map or vector based image file as the canvas (1512).

Once the canvas (1512) has been defined, a user may then define portions of the canvas (1512) as content slides by interactively defining a boxed region (1514) over a portion of the canvas (1512) that the user would like to capture as a content slide. Once the boxed region (1514) is defined, the user may select a record slide button (1530) to initiate a capture of the defined region of the canvas as a content slide. Once a content slide is defined, a smaller copy of the content slide may be placed in slide list toolbar 1520 in the order in which it was defined. Once in the slide list toolbar 1520, the defined slides may be manipulated as described previously above. For example, they may be reordered, duplicated or deleted.

A user may define multiple content slides by consecutively defining portions of the canvas (1512) to be converted into a slide. For example, a user may define a second boxed region (1516) that overlaps two areas of the canvas (1510) that are labeled for use as slides. Once defined, a user may then create a content slide that corresponds to the boxed region (1516) using the record slide button (1530). The user may also insert special slides (e.g. backgrounds, transition, sections, etc.) in a manner similar to that described above.

Once the slides have been defined in the authoring mode interface (1500), a user may view the presentation similarly to that described above. As the user cycles through the defined slide areas, the presentation interface view pans and zooms around the defined canvas as defined by the presentation and the interaction with the presentation.

FIG. 16 shows another alternative authoring mode interface (1600) for defining a set of slides and a canvas. The authoring mode interface 1600 may function similarly to that of the authoring mode interface (1500) of FIG. 15. That is, rather than a user defining a set of slides and an application then generating a canvas therefrom, the authoring mode interface (1600) provides a user interface that allows a user to first define a canvas and to then define the slides.

A user may define slides by first defining a canvas similar to that discussed above with reference to the authoring mode interface (1500) of FIG. 15. Once a user has defined a canvas, the user may then zoom and pan the canvas such that a canvas view port (1610) shows a desired portion of the canvas. The user may then use a record slide button (1630) to record the portion of the canvas being viewed in the view port (1610) as a slide. The recorded slide may then be inserted into a slide list toolbar 1620. The user may also insert special slides in a manner similar to that described above.

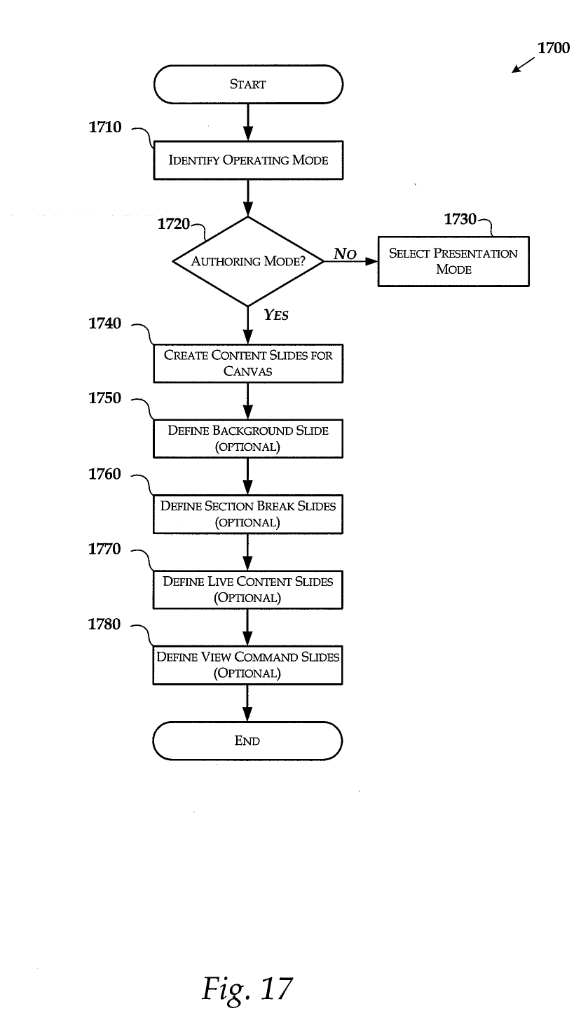

FIG. 17 illustrates an example flow chart (1700) for a method of defining a slide presentation on an infinite surface. Flow chart 1700 includes processing blocks 1710-1780.

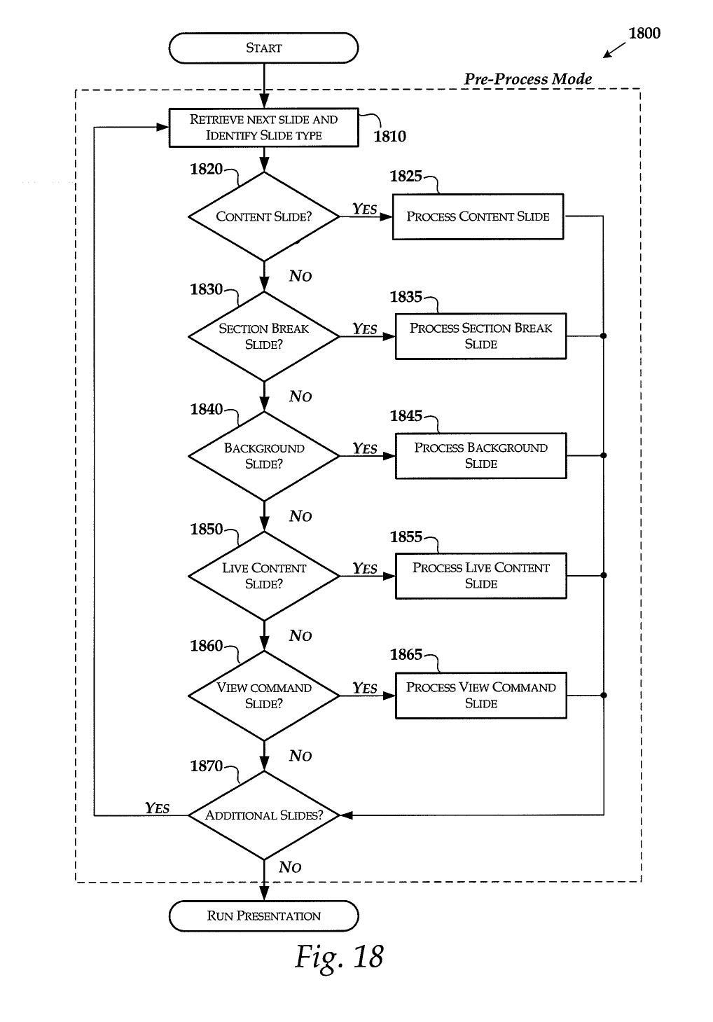

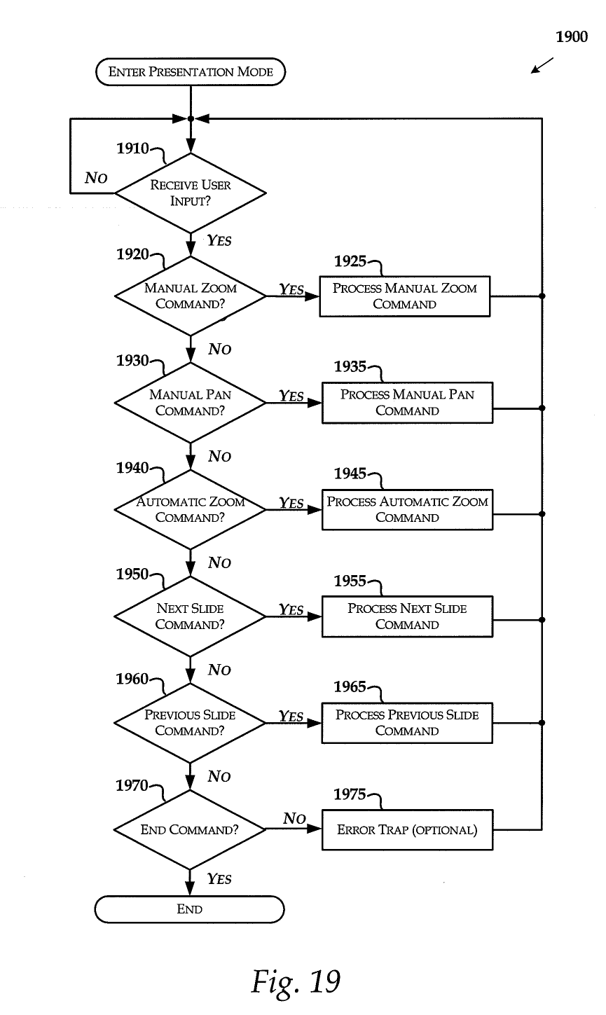

Processing begins at block 1710. At block 1710 the process identifies the mode of operation of a slide show application, such as authoring mode or presentation mode. Continuing to decision block 1720, the process determines whether the mode is authoring mode. If the mode of operation is determined not to be authoring mode, the process flows to processing step 1730 where the presentation mode is selected and the preprocessing mode is automatically first entered. See FIGS. 18 and 19 and related discussion.

If the mode of operation is determined at decision block 1720 to be the authoring mode, the process flows to bock 1740. At block 1740, the authoring mode interface is used to define content slides. In some examples, slides may be defined by importing them into the authoring mode interface. In other examples, slides may be defined by using standard word processing and graphical editing tools to create the slides. Slides may also be defined by first creating a canvas and then designating portions of it as content slides (see prior discussion).

Continuing to block 1750, a background slide may optionally be defined. In some examples, a user may wish to use the default background and this step may, therefore, be omitted. In other examples a user may wish to customize the appearance and layout of the canvas and define a background slide. The background slide may be defined by selecting a pre-created background template. When a user desires greater control, the background slide may also be defined by manually creating a background or modify a template. In some examples a single background slide may be defined that controls the complete presentations while in other examples multiple background slides may be defined for different parts of the presentation.

Flowing to block 1760, section break slides may optional be defined. In some examples, a section break slide may be inserted into the slide list with no further user input before playing the presentation. In this case, the default section break settings may be used to create a section. In other examples, a user may modify metadata associated with the section break slide using the authoring mode user interface to control the appearance of the section and how slides will be grouped into the section (see discussions related to FIG. 9).

Continuing to block 1770, live content slides may optionally be defined. When a user wants to integrate a document from another file into the presentation, a live content slide may be used. To define a live content slide a user may define the name of the file that is to be referenced and the location of the file. In some examples, the authoring mode user interface may automatically determine whether the address should be specified as a relative address or an absolute address. This determination may be in response to whether the file being referenced is located in a sub-directory (sub-folder) of the directory (file folder) in which the presentation file is located. In other examples, a user may manually determine whether the address of the file being referenced should be specified as a relative address or an absolute address.

Flowing to block 1780, view command slides may optionally be defined. When a user wants to specify an alternative to the default way in which the presentation will be displayed, a user may define a view command slide. In some examples, the view command slide may control the transition between two slides. For example, the view command slide may control the manner in which the view is adjusted when the presentation transitions between slides upon receipt of a next slide command. In other examples, the view command may simply instruct the zoom level to increase or decrease. In still other examples, a view command slide may be defined that alters the transition for the complete presentation. Following the optional definition of view command slide, the process flows to an end block and the exemplary process for creating the presentation is complete, and the presentation can be saved for later retrieval.

FIG. 18 illustrates an example flow chart (1800) for a method of preprocessing a presentation before the presentation mode has been entered. This may occur, for example, upon execution of the process of block 1730 of FIG. 17. Flow chart 1800 includes processing blocks 1810-1870.

Processing begins at block 1810. At block 1810, the process retrieves a next slide and identifies the type of slide. For example, a slide may be a content slide or a special slide, such as a section break slide, a background slide, a live content slide, or a view command slide.

Continuing to decision block 1820, the process determines whether the retrieved slide is a content slide. If it is a content slide, the process flows to block 1825 and the content slide is processed. Processing a content slide may include, for example, beginning the construction of a canvas and inserting the content slide onto the canvas for presentation. When processing the content slide is completed at block 1825, the process returns to block 1870. When decision block 1820 determines that the retrieved slide is not a content slide, the process flows to decision block 1830.

At decision block 1830, the process determines whether the retrieved slide is a section break slide. If it is a section break slide, the process flows to block 1835 and the section break slide is processed. Processing a section break slide may include, for example, grouping content slides into a section according to metadata associated with the retrieved section break slide. Processing may also include grouping live content slides into the section when live content slides are present. Processing a section break slide may further include generating the appearance of the section on the canvas according to the presentation and section settings. In some examples each section may individually define its appearance and behavior, while in other examples the presentation may uniformly define the appearance of all sections. Processing a section break slide may further include determining which slides are to be grouped into the section and the layout of those slides. When processing the section break slide is completed at block 1835, the process continues to block 1870. When decision block 1830 determines that the retrieved slide is not a background slide, the process flows to decision block 1840.

At decision block 1840, the process determines whether the retrieved slide is a background slide. If it is a background slide, the process flows to block 1845 and the background slide is processed. Processing a background slide may include, for example, altering the appearance of the canvas to include a background image according to the image associated with the background slide. Processing the background slide may also include placing content slides and sections into content boxes associated with the backgrounds slide. When processing the background slide is completed at block 1845, the process continues to block 1870. When decision block 1840 determines that the retrieved slide is not a background slide, the process flows to decision block 1850.

At decision block 1850, the process determines whether the retrieved slide is a live content slide. If it is a live content slide, the process flows to block 1855 and the live content slide is processed. Processing a live content slide may include, for example, loading the referenced file into memory. Once loaded, a file type may be determined. An image of the file may be rendered that shows the file as it would appear if rendered by a native application associated with the file type. Once the image has been generated, it may be placed onto the live content slide on the canvas. In this manner, the live content file may be displayed on the canvas as an image of the state of the referenced file as of the time the presentation mode is entered. Thus, the most recent version of the referenced file may be displayed. In some examples, the referenced file may be displayed as a slide that is composed solely of an image of the referenced file. In other examples, where the file referenced by the live content slide includes multiple pages, processing may include creating multiple images from the pages of the referenced file. Where multiple pages are present, displaying the live content slide may include displaying not only an image of the referenced file, but also displaying user interface elements (e.g. controls) that allow a user to navigate though the multiple pages of the file. In some examples, images may be taken of all of the pages of the live content document when the presentation mode is entered. In other examples, images maybe created of each page individually on an as-needed basis. In this case, memory usage may be reduced and the most up-to-date version of the referenced file is ensured. In still other examples, images may be taken of the live content document at any other time. When processing the live content slide is completed at block 1855, the process continues to block 1870. When block 1850 determines that the retrieved slide is not a live content slide, the process flows to decision block 1860.

At decision block 1860, the process determines whether the retrieved slide is a view command slide. If it is a view command slide, the process flows to block 1865 and the view command slide is processed. Processing a view command slide may include, for example, inserting a command in the presentation to alter the view of the canvas at a particular time. In some examples the view command slide may describe a transition between two slides, while in other examples the view command slide may simply describe a zoom, pan, rotation or other change in view. Processing the view command slide inserts the needed commands into the presentation to alter the view as described in the view command slide. When processing the view command slide is completed at block 1865, the process continues to block 1870. When decision block 1860 determines that the retrieved slide is not a background slide, the process flows to decision block 1870.

At decision block 1870, the process determines whether there are additional slides to be to be retrieved and processed. If there are no additional slides and all of the slides in the slide list have been processed, the process flows to a run presentation block where the presentation is executed, as is described below with reference to FIG. 19. If there are additional slides, the process returns to block 1810 where the next slide is retrieved and identified and the above process repeats until all slides are processed.

FIG. 19 illustrates an example flow chart (1900) for a method of running a canvas presentation in presentation mode after preprocessing the presentation has been completed (e.g. in preprocessing mode). Flow chart 1900 includes processing blocks 1910-1975.

Processing begins by flowing into decision block 1910. At decision block 1910, the process determines whether a user input has been received. If no user input has been received, the process returns to block 1910. When a user input has been received, the process flows to decision block 1920.

At decision block 1920, the process determines if the received user command is a manual zoom command. If it is a manual zoom command, the process flows to block 1925 and the manual zoom command is processed. Processing a manual zoom command may include, for example, zooming in the current view of the canvas such that additional detail can be seen. Processing a manual zoom command may also include decreasing the zoom level such that a greater portion of the canvas may be viewed. When processing the manual zoom command is completed at block 1925, flow returns to decision block 1910 where the process waits for a next command to be received. When decision block 1920 determines that the retrieved command is not a manual zoom command, the process flows to decision block 1930.

At decision block 1930, the process determines if the received user command is a manual pan command. If it is a manual pan command, the process flows to block 1935 and the manual pan command is processed. Processing a manual pan command may include, for example, panning the current view of the canvas such that different portions of the canvas may be viewed. In some cases, this may cause multiple slides to be viewed simultaneous. Processing a manual pan command may also include rotating the canvas. When processing the manual pan command is completed at block 1935, flow returns to block 1910 where the process waits for a next command to be received. When decision block 1930 determines that the retrieved command is not a manual pan command, the process flows to decision block 1940.

At decision block 1940, the process determines if the received user command is an automatic zoom command. If it is an automatic zoom command, the process flows to block 1945 and the automatic zoom command is processed. Processing an automatic zoom command may include, for example, increasing the zoom level to an automatically determined zoom level such that additional details may be viewed. For example, if the full canvas is currently being viewed the zoom level may be increased to a level automatically determined so an indicated section may fill the view (changing the zoom level from a canvas zoom level to a section zoom level). In another example, if a full section is currently being viewed the zoom level may be increased to a level automatically determined so an indicated slide may fill the view (changing the zoom level from a section zoom level to a slide zoom level).

Processing an automatic zoom command may include, for example, decreasing the zoom level to an automatically determined zoom level such that a greater portion of the canvas may be viewed. For example, if a full slide is currently being viewed the zoom level may be decreased to a level automatically determined so the full section in which the slide is located may fill the view (changing the zoom level from a slide zoom level to a section zoom level). In another example, if a full section is currently being viewed the zoom level may be decreased to a level automatically determined so that the full canvas may be viewed (changing the zoom level from a section zoom level to a canvas zoom level).

When processing the automatic zoom command is completed at decision block 1945, flow returns to block 1910 where the process waits for a next command to be received. When decision block 1940 determines that the retrieved command is not an automatic zoom command command, the process flows to decision block 1950.

At decision block 1950, the process determines if the received user command is a next slide command. If it is a next slide command, the process flows to block 1955 and the next slide command is processed. Processing a next slide command may include keeping track of which slide is a present slide marker. When a next slide command is received, the slide following the present slide marker may be brought into view. For example, if no slide has yet been set as the present slide when a next slide command is received the view may be modified so that the first slide may fill the view. The present slide marker may then be set to the first slide. When another next slide command is received, the second slide may be brought into view and the present slide market set to the second slid. In other examples, the next slide command may display a next viewport, this may be a slide, a section, an overview or any other viewport defined on the canvas.

When the slide following the present slide is the first slide of a section, rather than displaying the next slide, the section that contains the next slide may be displayed. In this way, an overview of the section may first be presented. Once the overview is presented, when another next slide command is received, the next slide may then be displayed.

Similarly, when the present slide is the last slide of a section, rather than displaying a slide outside of the section, the section that contains the present slide may be displayed. In this way, a review of the section may first be presented. Once the review is presented, when another next slide command is received, the next slide may then be displayed.

When processing the next slide command is completed at block 1955, flow returns to decision block 1910 where the process waits for a next command to be received. When decision block 1950 determines that the retrieved command is not a next slide command, the process flows to decision block 1960.

At decision block 1960, the process determines if the received user command is a previous slide command. If it is a previous slide command, the process flows to block 1965 and the previous slide command is processed. Processing a previous slide may be similar to that of a next slide. Processing a previous slide command may also utilize the present slide marker (e.g. current slide). When a previous slide command is received, the slide preceding the present slide may be brought into view. In some examples, preview and review views may be generated, similar to that of the processing of a next slide command block 1955.

When processing the previous slide command is completed at block 1965, flow returns to block 1910 where the process waits for a next command to be received. When decision block 1960 determines that the retrieved command is not a previous slide command, the process flows to decision block 1970.

At decision block 1970, the process determines if the received user command is an end command. If it is an end command, the process flows to an end block and the process ends. If the received command is not an end command, the process flows to block 1975. At block 1975, an error trap process is optional executed. This process may include standard error handling functionality, such as presenting an error message to the user that states that the received command is not recognized. After the optional processing is complete, flow returns to decision block 1910 where the process waits for a next command to be received.

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended. Additionally, embodiments shown in flow diagrams may be implemented with process steps executed in alternative orders. In some examples, steps may be implemented in parallel or in series.

What is claimed is:

1. A method of creating a slide presentation comprising:
defining a plurality of slides;
associating the plurality of slides with a background canvas; and
automatically defining navigation functions for the slide presentation such that navigation though the slides during the slide presentation is achieved by adjusting a view to one or more of the plurality of slides relative to the background canvas in response to the automatically defined navigation functions.

2. The method of claim 1, wherein associating the plurality of slides with the background canvas includes automatically arranging the plurality of slides on the background canvas.

3. The method of claim 1, wherein automatically defining navigation functions for the slide presentation comprises automatically defining navigation functions for each of the plurality of slides in response to a user initiated command to play the slide presentation.

4. The method of claim 1, wherein defining the plurality of slides includes defining a background slide that includes a background definition and defining a content slide that includes content for displaying during the slide presentation.

5. The method of claim 3, wherein associating the plurality of slides with a background canvas includes:
rendering the background canvas responsive to the background definition of the background slide; and
arranging the content slide on the background slide responsive to the background definition of the background slide.

6. The method of claim 1, wherein defining the plurality of slides includes:
defining a plurality of content slides that each include content for displaying during the slide presentation; and
defining a section break slide in the slide presentation, wherein the section break slide includes a section definition that defines a slide group including one or more of the plurality of content slides.

7. The method of claim 6, wherein associating the plurality of slides with the background canvas includes arranging the plurality of content slides on the background canvas in response to the section definition such that each content slide of the slide group is organized for display during the slide presentation as a physical arrangement that is graphically differentiated from each content slide not included within the slide group.

8. A tangible computer readable storage medium encoded with computer executable instructions for creating a slide presentation, comprising:
defining a plurality of slides;
associating a canvas with the plurality of slides; and
automatically configuring navigation functions for the slide presentation such that navigation though the slides during the slide presentation is achieved by adjusting a view to a portion of the canvas in response to the automatically configured navigation functions.

9. The tangible computer readable storage medium of claim 8, wherein associating the canvas with the plurality of slides includes arranging the plurality of slides on the canvas such that each slide is placed on a different portion of the canvas.

10. The tangible computer readable storage medium of claim 8, wherein automatically configuring navigation functions for the slide presentation comprises automatically defining navigation functions for each of the plurality of slides in response to a user initiated command to play the slide presentation.

11. The tangible computer readable storage medium of claim 8, wherein defining the plurality of slides includes:
defining a plurality of content slides that each include content for displaying during the slide presentation; and
defining a section break slide in the slide presentation, wherein the section break slide includes a section definition that defines a slide group that including one or more of the plurality of content slides.

12. The tangible computer readable storage medium of claim 11, wherein associating the canvas with the plurality of slides includes arranging the plurality of content slides at different positions on the canvas in response to the section definition such that each content slide of the slide group is positioned for displaying as a grouped arrangement that is graphically differentiated from each content slide not included within the slide group.

13. The tangible computer readable storage medium of claim 11, wherein defining the plurality of slides includes defining a background slide having a background definition that includes:
a background image for displaying across the canvas; and
a plurality of content boxes that define different regions of the canvas such that each of the plurality of content slides are placed at a corresponding one of the different regions.

14. The tangible computer readable storage medium of claim 13, wherein associating the canvas with the plurality of content slides includes:
rendering the canvas responsive to the background definition of the background slide; and
arranging the plurality of content slides on the canvas in an arrangement that is responsive to the section definition for the slide group such that each content slide of the slide group is displayed at a different physical positions within the region of the canvas defined by the corresponding content box for the slide group.

15. The tangible computer readable storage medium of claim 8, wherein defining the plurality of slides includes defining a live content slide, wherein the live content slide is arranged to reference an external file associated with a file type.

16. The tangible computer readable storage medium of claim 15, further comprising:
rendering an image of the external file such that the rendered image comports in appearance to an image from a native application associated with the file type for the external file; and
displaying the rendered image of the external file at a graphical position on the canvas associated with the live content slide.

17. A tangible computer readable storage medium that includes computer executable instructions for an application that creates a slide presentation, the application comprising:
an authoring mode for the application, wherein a user interface is arranged for defining a plurality of slides for the slide presentation when the authoring mode is active;
a preprocessing mode for the application, wherein the preprocessing mode is activated in response to a play command that is initiated from the user interface in the the slide presentation by creating a background canvas and arranging the plurality of slides on the background canvas when the preprocessing mode is active; and
a presentation mode, wherein the presentation mode is activated after completion of preprocessing in the preprocessing mode; wherein the presentation mode is arranged to display the canvas and the slides arranged thereon when active.

18. The tangible computer readable storage medium of claim 17, wherein the authoring mode is arranged for defining a view command slide, wherein the view command slide defines a command to alter the manner in which one or more portions of the canvas are displayed during the presentation mode.

19. The tangible computer readable storage medium of claim 18, wherein the presentation mode is arranged for changing a current display to a different portion of the canvas in response to the view command slide during the presentation mode.

20. The tangible computer readable storage medium of claim 17, wherein the presentation mode is arranged for changing a current display to a different portion of the canvas in response to a user initiated input received during the presentation mode.
